(19) United States
(12) Patent Application Publication
(10) Pub. No.: US 2007/0137980 A1
(43) Pub. Date: Jun. 21, 2007

(54) Stepchain link for a passenger conveyor system

(76) Inventors: Helmut Meyer, Bueckeburg (DE); Andreas Stuffel, Bueckeburg (DE); Jorg Ostermeier, Buckeberg (DE); Helene Ostemeier, Buckeburg (DE); Heike Engel Rojahn, Buckeberg (DE)

Correspondence Address: Karin H Butchko;Carlson Gaskey & Olds, Suite 350, 400 W Maple Road, Birmingham, MI, 48009, US

(21) Appl. No.: 10/538,461

(22) PCT Filed: Feb. 7, 2003
(86) PCT No.: PCT/US03/03801

§ 371 Date: Nov. 17, 2006

(30) Foreign Application Priority Data
Dec. 13, 2002 (US) PCT/US02/39945

(51) Int. Cl. B66B 21/00

(52) U.S. Cl. 198/327; 198/330; 198/333

(57) ABSTRACT

A stepchain for a passenger conveyor includes a plurality of stepchain links (30, 130, 230). There is only one link-to-link interface (31) on each side of the steps (24) such that the number of links (30) on each side of the steps (24) is equal to the number of steps (24). The inventive arrangement reduces rotation or contraction of the stepchain between steps (24). Elongation of the stepchain is also reduced as there is a reduction in the number of interfaces (31). The inventive arrangement also facilitates arcuate movement of the steps (24) along a constant radius through the transition zones between the inclined area (27) and the landing areas (29). Having a truly arcuate movement allows for reducing the gap (33) between the steps (24) at the transition zones. In one example at least one needle bearing (190) is associated with an attachment mechanism (184, 284) at the interface (31) between adjacent links (30) to allow for rotation between the stepchain links (30) and to eliminate the need for lubrication.

### BACKGROUND OF THE INVENTION

This invention generally relates to passenger conveyor systems. More particularly, this invention relates to a stepchain for a passenger conveyor.

Conventional passenger conveyors, such as escalators or moving walkways, include a chain of steps that travel in a loop to provide a continuous movement along a specified path. The steps are connected to a continuous loop of stepchain links that interact with a drive mechanism. As the stepchain links move, the steps move as desired. The stepchain links are connected to each other at an interface by an attachment member, such as a pin, that is received in aligned holes in the ends of adjacent stepchain links.

In conventional passenger conveyor systems, there are several stepchain link-to-stepchain link interfaces associated with each step. In one prior art passenger conveyor system, three to five stepchain link interfaces are employed per step. Some of the stepchain links are attached to the interfaces, and therefore, to corresponding steps. Other stepchain links are inserted between the attached stepchain links but are not attached to the steps.

The stepchain links that are not attached to the steps can pivot at the interfaces between the stepchain links, causing contraction of the stepchain between steps. If the stepchain contracts, the rear edge of the tread surface of the step travels in a non-circular curve while the step travels through the transition areas of the passenger conveyor system, causing the clearance between the rear edge of the tread surface of the step and the rise surface of the adjacent step to vary while the step transitions between the inclined area and the landing areas. If the clearance increase too much, there is a risk of entrapment of objects.

The interfaces between the stepchain links wear overtime, which can cause the stepchain to elongate and the clearances between steps to increase in size. If several interfaces per step are employed in a passenger conveyor system, there is an increased possibility of elongation of the stepchain as there is a greater number of interfaces.

Another disadvantageous feature of conventional arrangements is that they typically require periodic lubrication at the interfaces between the links.

The drive mechanism of the passenger conveyor system is commonly located in the upper landing area. The pressure at each interface is dependent on the location of the interface in the passenger conveyor system. As the interface travels towards the drive mechanism in the upper landing area, the pressure at the interface increases, increasing the tension in the stepchain and the chain stress value. This is disadvantageous as the increase in chain stress value contributes to stepchain elongation, which can cause an increase in the clearances between adjacent steps and cause entrapment of objects.

Hence, there is a need in the art for an arrangement that does not suffer from the elongation, clearance, stepchain stress, and lubrication drawbacks and shortcomings of the prior art. This invention includes a stepchain link which has a one stepchain link to stepchain link interface per step and has needle bearing at the stepchain link to stepchain link interface and avoids the other mentioned problems associated with prior designs.

### SUMMARY OF THE INVENTION

In general terms this invention is a passenger conveyor system that includes a unique stepchain configuration that facilitates interaction between the stepchain and a drive mechanism. In a preferred example, the number of stepchain links on each side of the steps is equal to the number of steps.

In one example, there is only one stepchain link-to-stepchain link interface per each side of each step. In such an arrangement, the stepchain does not rotate or contract between steps because there are no link interfaces between the steps.

In one example, one edge of each step tread surface moves along an arc of a circle as the steps and the stepchain links transition between the inclined area and the landing areas as there is no contraction of the stepchain. The clearance between the one edge of the tread surface of one step and the rise surface near an opposite edge of the adjacent step remains constant in the transition areas. Additionally, as there are fewer stepchain link-to-stepchain link interfaces in the inventive arrangement, there is a reduction in stepchain elongation otherwise due to interface wear.

In one example, the stepchain links are made of die cast metal. When attached, each stepchain link includes a first end that is received between two spaced apart portions in a second end of another stepchain link. The first end and the second end of the stepchain links have holes that are aligned when assembled. An attachment mechanism is inserted in the aligned holes to secure the stepchain links together. In one example, each stepchain link includes a bridge support to support a bridge positioned between the disc members of adjacent steps. Needles bearings are located in the holes of the two spaced apart portion of the first end of each stepchain link between the holes and the attachment mechanism. The needle bearings allow for rotation between the stepchain links, eliminating the need for lubrication and reducing wear at the stepchain link to stepchain link interface.

A second example stepchain link is made of steel. The steel can be stamped steel or laser cut steel. Each stepchain link includes two inner portions having a plurality of inner holes. The ends of the inner portions are secured to the ends of another two inner portions by an attachment mechanism. The two inner portions of each link are positioned in an outer portion including a first side, a second side, and a bottom having a plurality of teeth. The first side and the second side have a plurality of outer holes that align with the inner holes of the two inner portions. An attachment member extends through the aligned holes to secure the two inner portions to the outer portion. Needle bearings can also be employed around the attachment member to reduce wear. In one example, the attachment members have a square cross section and are interference fit into correspondingly shaped attachment holes. The two inner portions bear the tensile load of the chain, and the outer portion engages the drive member.

In another example embodiment, a plate of injection molded plastic teeth are snapped onto the bottom edge of the two secured inner portions. The plastic teeth engage the drive member.

These and other features of the present invention will be best understood from the following specification and drawings.

### BRIEF DESCRIPTION OF THE DRAWINGS

FIG. 1 schematically illustrates selected portions of a passenger conveyor system;

FIG. 2A schematically illustrates selected portions of an example drive assembly designed according to the present invention;

FIG. 2B schematically illustrates a side view of a passenger conveyor system and the pressures applied to a stepchain link interface as the interface travels around the passenger conveyor system;

FIG. 2C schematically illustrates a sectional side view of the one stepchain link to one stepchain link interface per step;

FIG. 2D schematically illustrates a side view of the movement of the rear edge of the tread surface of the steps during transition between the inclined area and a landing area;

FIG. 3 schematically illustrates a step of the passenger conveyor system;

FIG. 4 schematically illustrates an axle and two example stepchain links;

FIG. 5 schematically illustrates, in perspective view, a first example stepchain link;

FIG. 6 schematically illustrates, in perspective view, two first example stepchain links attached;

FIG. 7A schematically illustrates a top view of FIG. 6 taken along line 7A-7A;

FIG. 7B schematically illustrates a side view of FIG. 7a taken along line 7B-7B;

FIG. 7C schematically illustrates elongation of the stepchain links caused by wear;

FIG. 8A schematically illustrates a perspective view of the assembly of the inner portions of two of a second example stepchain links;

FIG. 8B schematically illustrates a perspective view of the attachment of the inner portions of two of a second example stepchain links;

FIG. 8C schematically illustrates a perspective view of the attachment of the outer portion to the second example stepchain links;

FIG. 8D schematically illustrates a perspective view of the attachment of the bridge to the two second example stepchain links;

FIG. 8E schematically illustrates a perspective view of the second example stepchain links after rotation of the pins and the axle;

FIG. 9 schematically illustrates an example outer portion of the second example stepchain link;

FIG. 10 schematically illustrates a cross-sectional view taken along the line 10-10 in FIG. 8D;

FIG. 11 schematically illustrates an end of the outer portion of the second example and an attachment member;

FIG. 12A schematically illustrates a top view of an example attachment member;

FIG. 12B schematically illustrates an end view of the example attachment member of FIG. 12A taken along line 12B-12B;

FIG. 13 schematically illustrates another example outer portion of a link including injection molded teeth;

FIG. 14 schematically illustrates a rear view of the bridge supported by the stepchain links of the present invention; and

FIG. 15 schematically illustrates a top view of FIG. 8C taken along line 15-15.

### DETAILED DESCRIPTION OF THE PREFERRED EMBODIMENTS

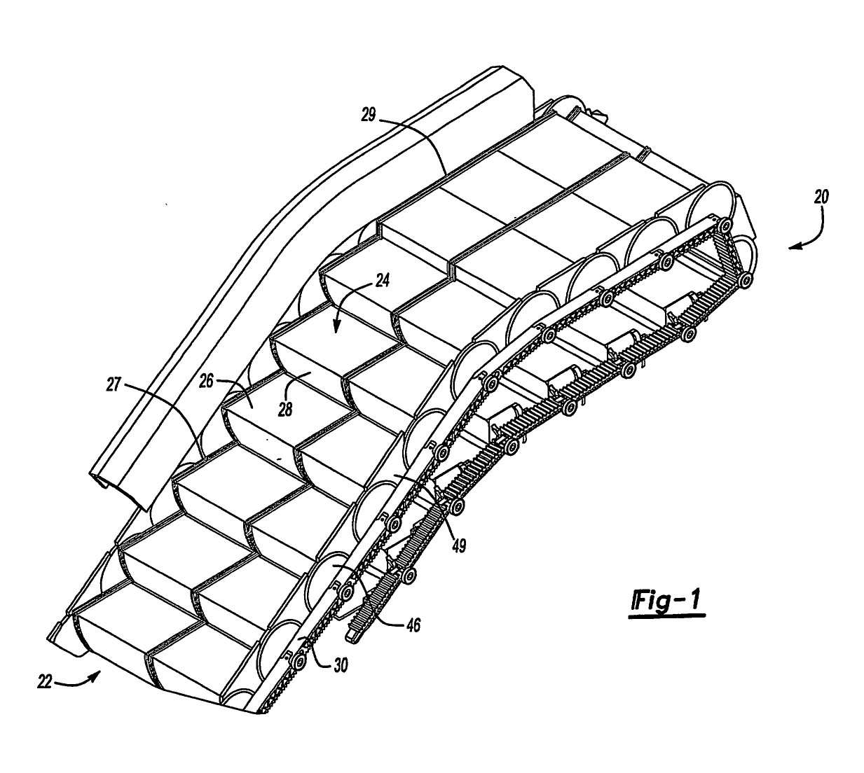

FIG. 1 schematically illustrates a passenger conveyor system 20. This example shows an escalator, but this invention is not so limited. Other conveyors are within the scope of this invention, such as moving walkways. This passenger conveyor system 20 includes steps 24 configured to travel in a loop, each step 24 having a tread surface 26 and a rise surface 28. A drive assembly 22 moves the plurality of steps 24 in a desired direction. The opposing ends of each step 24 include a disc member 46. A bridge 49 is positioned between the disc members 46 of adjacent steps 24 to close the gap between the disc members 46. If the passenger conveyor system 20 is an escalator, the passenger conveyor system 20 includes an inclined area 27 where the steps 24 ascend or descend and landing areas 29 where the steps move generally horizontally.

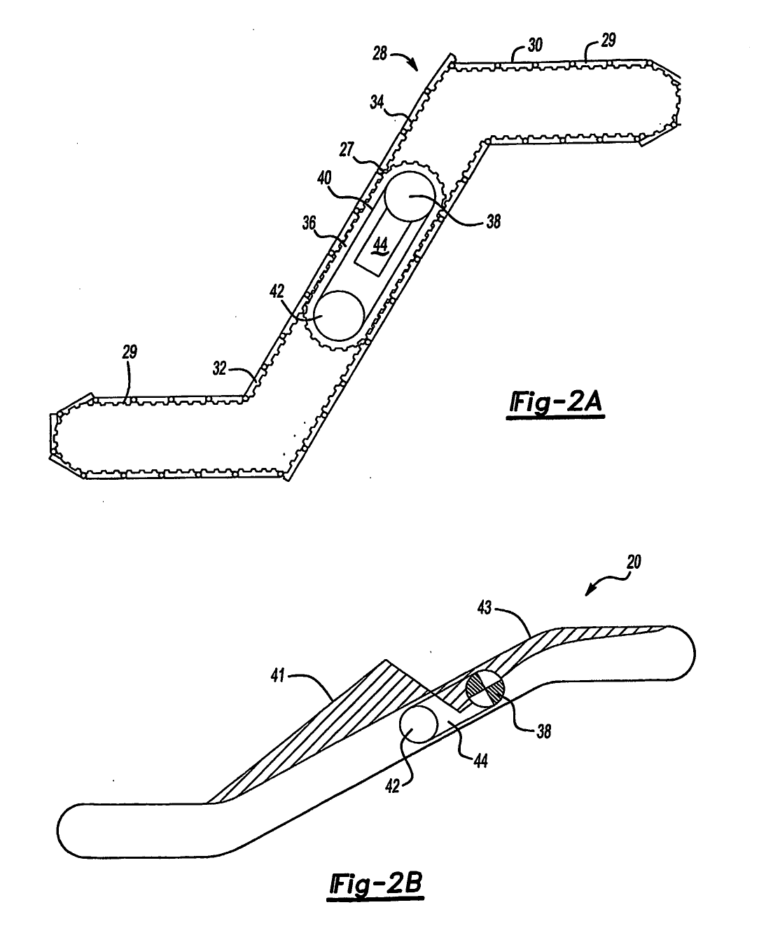

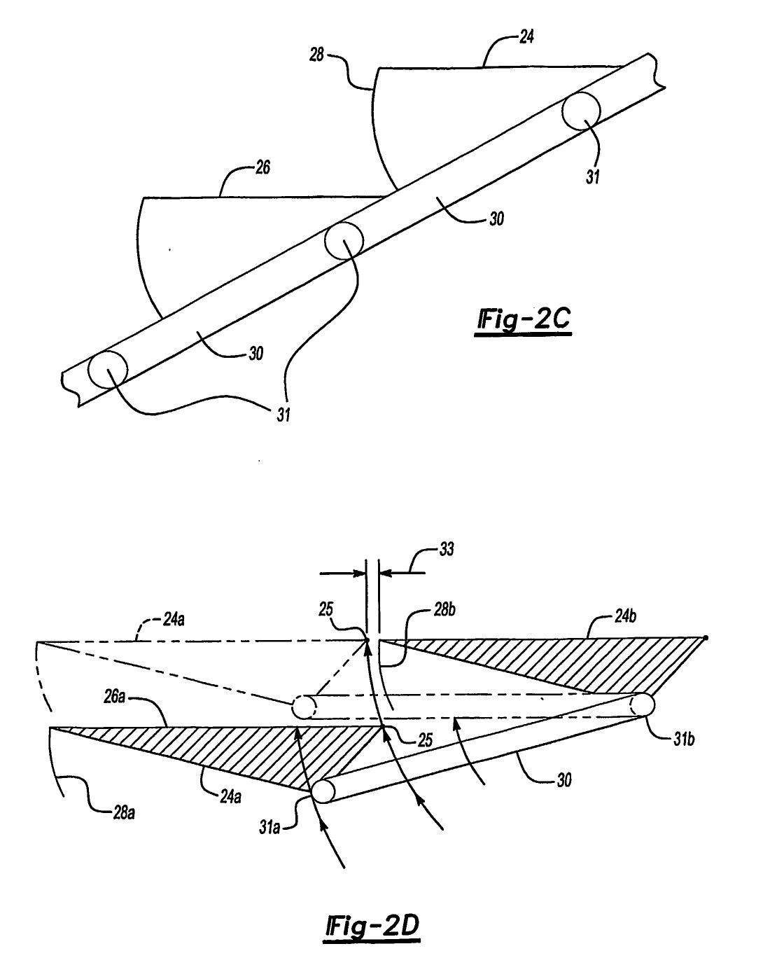

As further shown in FIG. 2A, the drive assembly 28 includes a plurality of stepchain links 30 which form a stepchain that follows a continuous loop corresponding to the loop followed by the steps 24. Each stepchain link 30 is connected to an adjacent stepchain link 30 at an interface 31. There is one stepchain associated with each side of the steps 24. The stepchain links 30 have a plurality of teeth 32 that engage an outer surface 34 of a drive member 36. Preferably, the outer surface 34 of the drive member 36 has a profile that corresponds to the profile of the plurality of teeth 32. In one example, each tooth 32 has a height of 5 mm and a pitch of 20 mm.

A drive sheave 38 engages an inner surface 40 of the illustrated drive member 36 to move the drive member 36 around a loop. An idle sheave 42 is positioned at an opposite end of the loop from the drive sheave 38. A drive mechanism 44 is schematically shown for moving the drive sheave 38 in the desired direction and at the desired speed. The drive mechanism 44 is located in the inclined area 27 of the passenger conveyor system 20 and includes a motor and a braking mechanism as known in the art, for example. Preferably, the passenger conveyor system 20 includes two drive members 36 running in parallel at the lateral edges of the steps 24 and two stepchains (i.e., sets of interlocked stepchain links 30) that cooperate with the drive members 36 to provide the desired system operation.

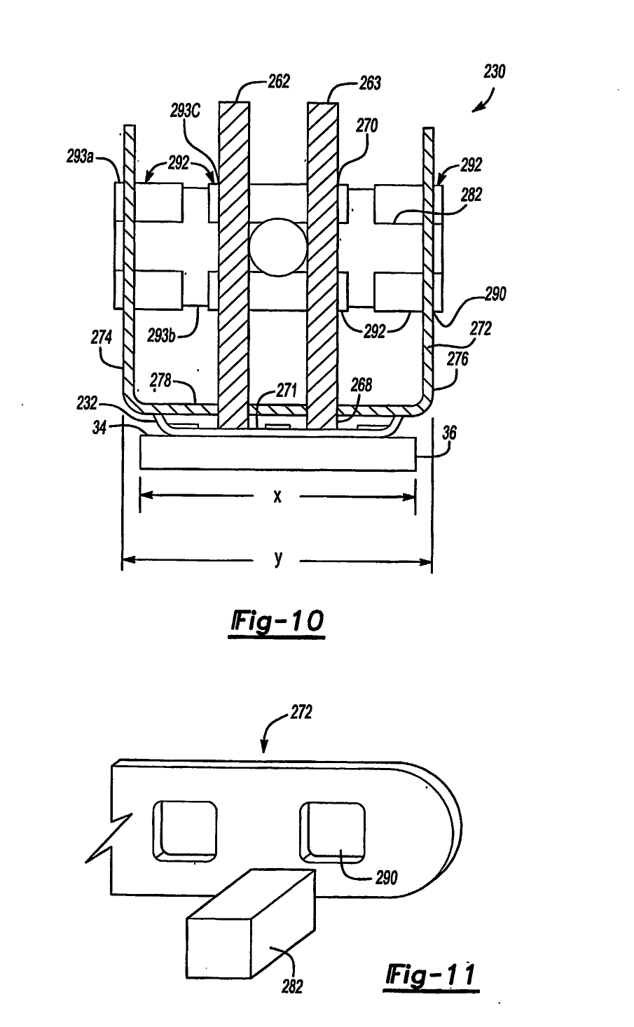

The drive member 36 in one example preferably has a width X of 65 mm wide and the stepchain links 30 preferably have a width Y of 70 mm (shown in FIG. 10). The drive member 36 in one example is a belt that is formed of polyurethane and includes a plurality of cords. In this example, the plurality of cords made of steel or Kevlar and are the tensile carrying portion of the drive member 36. The drive member 36 is formed by placing the cords in a two piece mold. Polyurethane is introduced into the mold, integrating the plurality of cords within the polyurethane. In such an arrangement, as the drive member 36 is polyurethane, lubrication is not needed between the stepchain links 30 and the drive member 36 as there is no metal-to-metal engagement. In another example, the drive member 36 is a drive chain.

Teeth 32 on the stepchain links 30 engage the outer surface 34 of the drive member 36 so that the steps 24 move responsive to the drive mechanism 44. Various tooth 32 profiles may be used, depending on the particular arrangement. In the illustrated example, the teeth 32 are made of an integrated single piece of material.

FIG. 2B schematically illustrates the amount of pressure applied to an interface 31 of the stepchain links 30 as the interface 31 travels around the passenger conveyor system 30. As the drive mechanism 44 is located in the inclined area 27 of the passenger conveyor system 20, there is a reduction in the stress value of the stepchain as compared to prior art passenger conveyor systems 20. The amount of pressure applied to the interface 31 is illustrated as the shaded areas, and is dependent on the location of the interface 31 in the passenger conveyor system 20.

The stress value on a given interface 31 is equal to the load applied on the interface 31 multiplied by the rotational speed. As an interface 31 travels within the passenger conveyor system 20 and approaches the drive mechanism 44, the pressure on the interface 31 increases, increasing the tension in the interface 31. When the interface 31 passes over the drive mechanism 44, the tension in the interface 31 is greatest. The tension on the interface 31 is represented by the shaded area 41 in FIG. 2B.

Immediately after the interface 31 passes over the drive mechanism 44 and continues to travel in the inclined area 27 of the passenger conveyor system 20, the interface 31 is compressed. As the interface 31 passes over the center of the drive mechanism 44, the compression of the interface 31 is the greatest. That is, the greatest compression in the interface 31 occurs immediately after the greatest tension on the interface 31. The compression of the interface 31 is represented by the shaded area 43. The compression of the interface 31 balances the tension applied on the interface 31, lowering the chain stress value.

There is no rotation of the stepchain links 30 at the area of the highest tension and highest compression load because the areas of highest tension and highest compression are located in the inclined area 27 of the passenger conveyor system 20. As the stress value on the chain equals the load applied on the interface 31 multiplied by the rotational speed, the stress value on the chain is lower than in the prior art because the locations of highest tension and compression are not located in the areas of high rotation, such as the upper transitions area and the upper turnaround. The system 20 of the present invention has a much lower chain load compared to the prior art, which typically had the drive mechanism 44 located between the transitions and the turnarounds. The stress value in the inventive arrangement is lower due to lower loads imposed on the stepchain link interfaces 31 associated with the steps.

FIG. 2C schematically illustrates a side view of two steps 24 and the associated stepchain links 30. Each stepchain link 30 is connected to an adjacent stepchain link 30 at the interface 31. The number of stepchain links 30 associated with each side of each step 24 is equal to the number of steps. There preferably is one stepchain link-to-stepchain link interface 31 supported on each side of each step 24. As there is only interface 31 per each side of each step 24, the stepchain does not rotate or contract between steps 24. This inventive arrangement prevents contraction of the stepchain.

Another feature of the illustrated example is that the steps 24 and the step chains move in a consistent pattern in the transition areas between the inclined area 27 and the landing areas 29. In the prior art, the chains followed a different path than the steps. Additionally, with the inventive arrangement, the pattern of movement is different that what occurs in conventional arrangements. One edge of the steps 24 and the link-to-link interfaces 31 move along an arc of a circle instead of moving along a curvilinear path having a non-constant radius.

Referring to FIG. 2D, first edges 25 of the tread surfaces 26 of the steps 24 move in an arc of a circle as the steps 24 and the stepchain links 30 transition between the inclined area 27 and the landing areas 29 of the passenger conveyor system 20. Such movement along an arc of a circle maintains a constant clearance 33 between the first edge 25 of the tread surface 26 of one step 24 and the rise surface 28 of the adjacent step 24. As the clearance 33 between adjacent steps 24 is constant, there is a reduced risk of entrapment of objects between the steps 24, especially in the transition areas.

FIG. 2D schematically illustrates the movement of the first edge 25 of the tread surface 26 of a step 24a when the step 24a transitions from the inclined area 27 to the landing area 29 of the passenger conveyor system 20. The shaded step 24a is located in the inclined area 27 and the shaded step 24b is located in the landing area 29. The stepchain link 30 is attached to the step 24a at the interface 31a, and the stepchain link 30 is attached to the step 24b at the interface 31b. The step 24a and the stepchain link 30 are shown in dashed lines in the landing area 29. As the step 24a moves between the inclined area 27 and the landing area 29, the first edge 25 of the tread surface 26a moves along an arc of a circle.

In the illustrated example, each step has an arcuate rise surface 28 near a second edge of the step opposite the first edge 25. In such example embodiments of this invention, the radius of curvature of the rise surface 28 is equal to the arc followed by the first edges 25 of the steps. As shown, the path of movement of the first edge 25 follows the shape of the rise surface 28b of the adjacent step 24b. Therefore, the clearance 33 between the rear edge 25 of the tread surface 26a of the step 24a and the rise surface 28b of the adjacent step 24b is constant while the steps 24a and 24b travel between the inclined area 27 and the landing areas 29 of the passenger conveyor system 20.

Such movement along an arc of a circle provides enhanced system performance and improved safety features. With conventional arrangements, the stepchain links and the steps did not follow the same path and neither followed a truly arcuate path, which introduced an increase in the gap or clearance between the steps in the transition zones. With the inventive arrangement, the clearance is constant and more tightly controlled, which reduces the likelihood for an object to become entrapped in between steps in the transition zones.

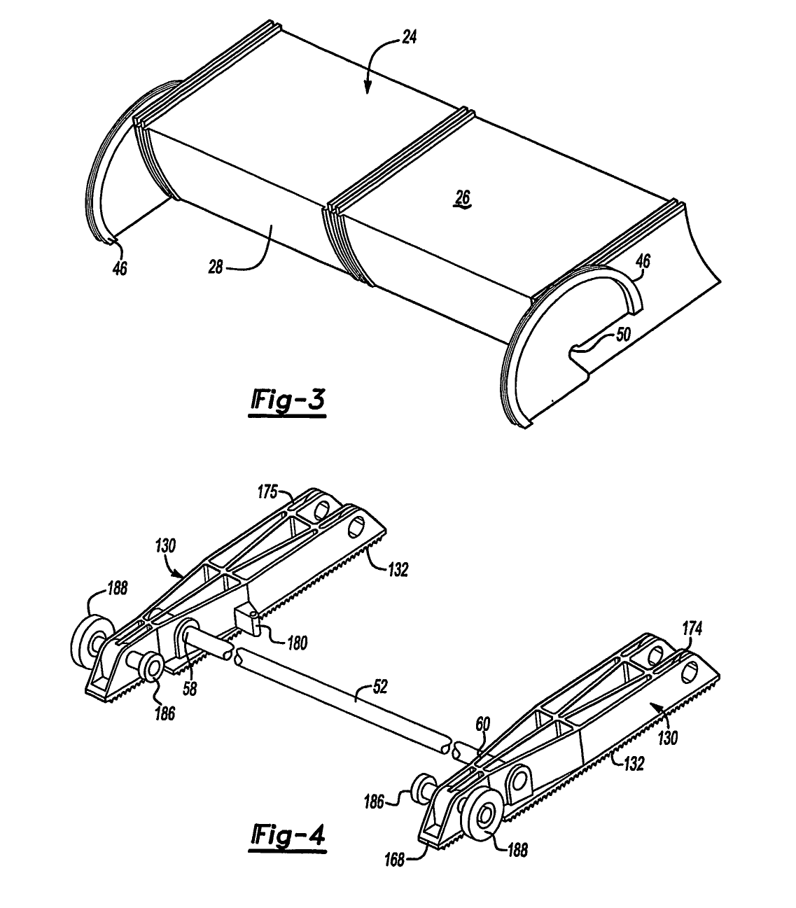

As shown in FIG. 3, each step 24 includes a disc member 46 adjacent each side edge of the step 24. The disc members 46 prevent objects from getting caught along the edges of the passenger conveyor system 20 during operation and moves with the steps 24.

As shown in FIG. 4, the ends 58 and 60 of the axle 52 are attached to a corresponding stepchain link 30. The cap 186 is attached by the hub portion 50 of the disc members 46 such that the stepchain links 30 are positioned outwardly of the disc members 46.

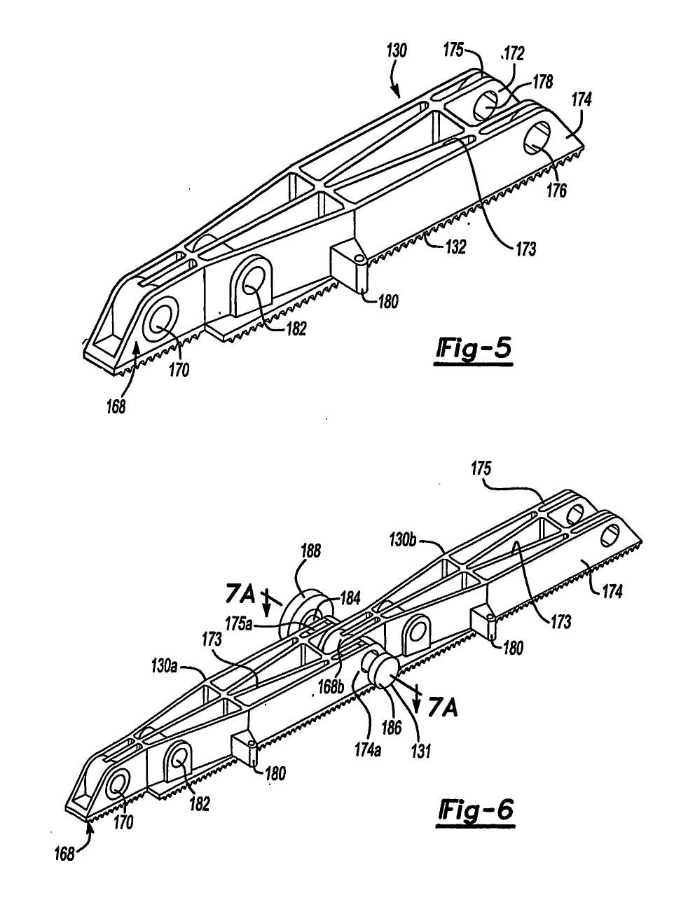

FIG. 5 illustrates a first example stepchain link 130 made of die cast metal, such as aluminum or magnesium. The stepchain link 130 includes a plurality of teeth 132, a first end 168 having a hole 170, and a second end 172 with two spaced portions 174 and 175 each having a hole 176 and 178, respectively. The axle 52 is press-fit into a hole 182 in the stepchain link 130.

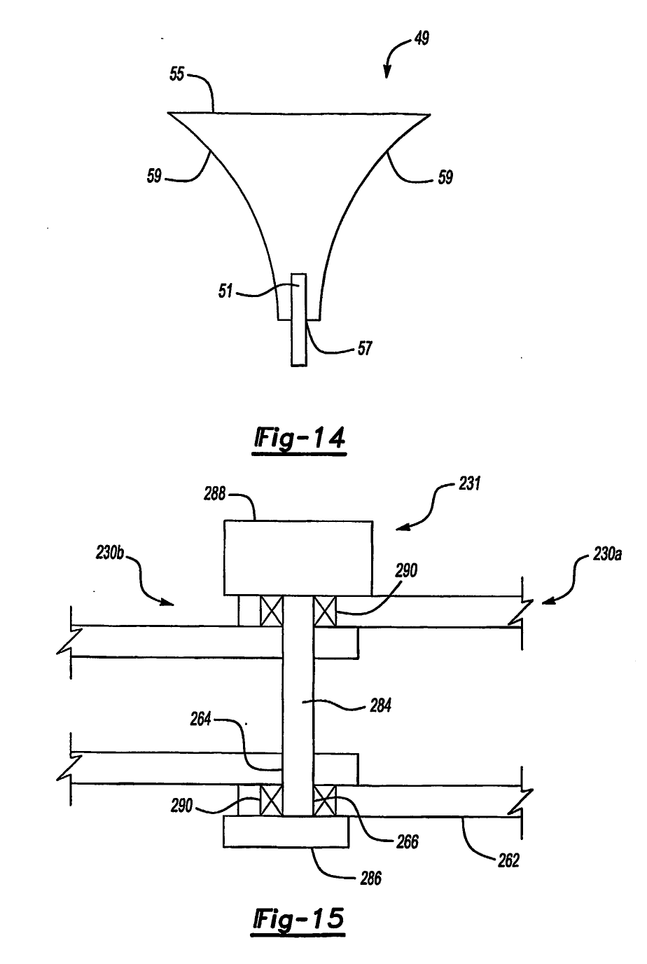

Each stepchain link 130 further includes a bridge support 180 which supports the bridge 49 positioned between the disc members 46 of adjacent steps 24 during operation of the conveyor system 20 (further shown in FIG. 1). The bridge 49, as further shown in FIG. 14, is preferably made of aluminum. The bridge 49 is substantially v-shaped and includes an enlarged upper end 55 and a smaller lower end 57. Sides 59 extend from the upper end 55 to the lower end 57. Each bridge 49 includes a pin 51 on the lower end 57 which is received in the bridge support 180, securing the bridge 49 to the stepchain link 130.

The link 130 further includes a webbed portion 173 which carries the tensile forces when the plurality of stepchain links 130 are in tension. The webbed portion 173 prevents bending and transfers tensile forces from the spaced portions 174 and 175 to the first end 168.

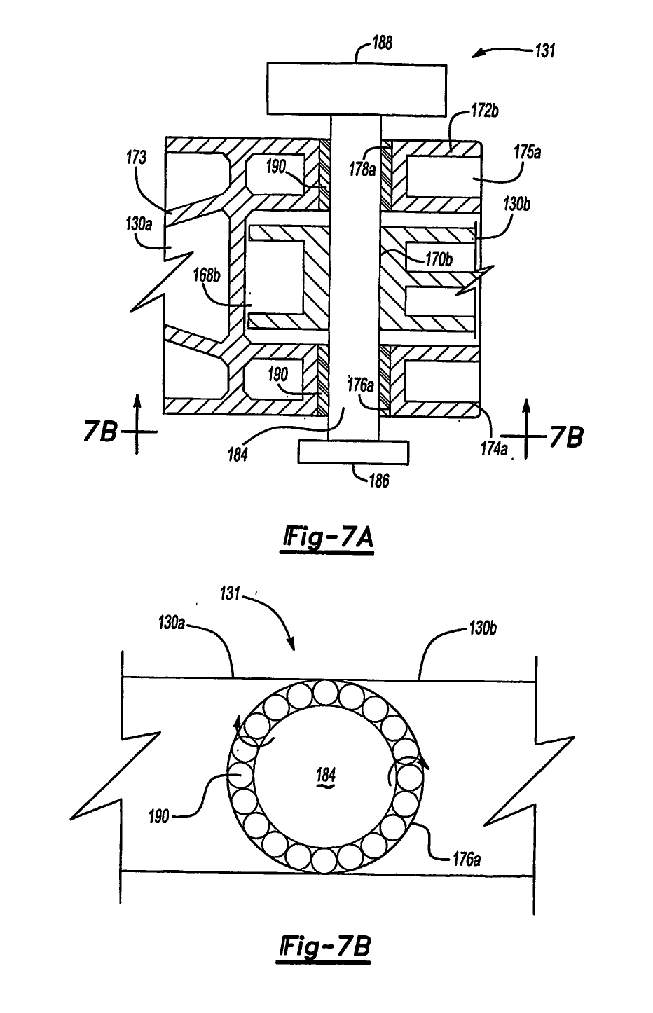

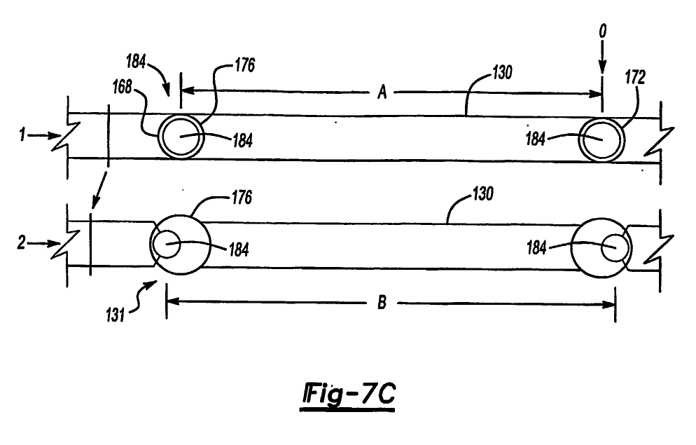

FIG. 6 illustrates an example pair of stepchain links 130a and 130b. The first end 168b of the stepchain link 130b is inserted between the two spaced apart portions 174a and 175a of stepchain link 120a. As shown in FIG. 7, the holes 170b, 176a and 178a are aligned and receive an attachment member 184, securing the stepchain links 130a and 130b together. A cap 186 and a stepchain roller 188 are attached to the opposing ends of the attachment member 184. The shouldered attachment member 184 secures the stepchain links 130a and 130b and is press fit in the hole 170b, fixing the distance between the wheel 64 and the cap 186.

FIGS. 7A and 7B illustrate the interface 131 of the stepchain link 130a and the stepchain link 130b. Needle bearings 190 are positioned between the attachment member 184 and the holes 176a and 178a, allowing for rotation between the stepchain links 130a and 130b and eliminating the need for lubrication. The needle bearings 190 rotate around the attachment member 184, reducing wear at the interface 131. The lubrication is sealed in the bearings 190 during assembly, eliminating the need to lubricate the bearing 190 during use.

As shown in FIG. 7C, the interface 131 of the stepchain links 130a and 130b elongates over time due to the wear. When the stepchain link 130 is new (the uppermost stepchain link 130 illustrated as 1), the distance between the centers of the attachment members 184 at the ends of the stepchain link 130 is distance A. As the interface 131 wears, the holes 176 and 178 (not shown) of the stepchain link 130 increase in size and the attachment member 184 received in the holes 176 and 178 decreases in size (the lowermost stepchain link 130 illustrated as 2). As shown, the distance between the centers of the attachment members 184 at the ends 168 and 172 of the stepchain link 130 is distance B, which is greater than distance A. This illustrates how the stepchain link 130 elongates over time due to wear. As there is only one interface 131 per step 24 in the passenger conveyor system 20 of the present invention, there is a reduction in elongation opportunities as there are fewer interfaces 131.

Although the stepchain links 130a and 130b have been described as having a first end 168 and a second end 172 with two spaced portions 174 and 175, it is to be understood that stepchain links 130a can include two first ends 168a and stepchain links 130b can include two second ends 172b having two spaced apart portions 174b and 175b. The stepchain links 130a and 130b are assembled in an alternating pattern to create a continuous loop.

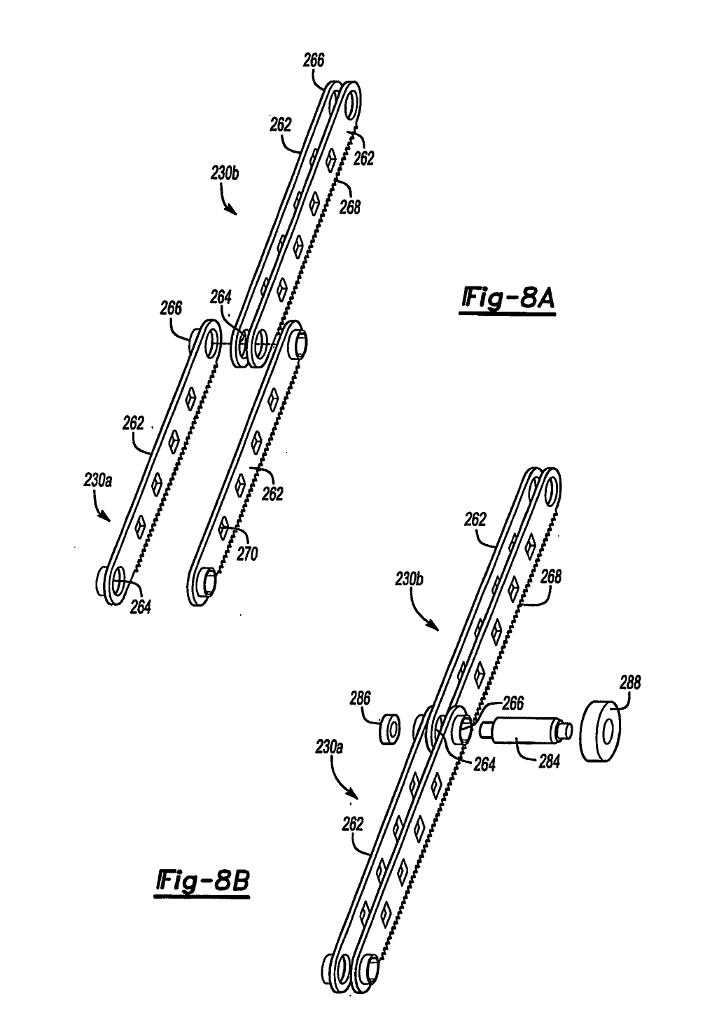

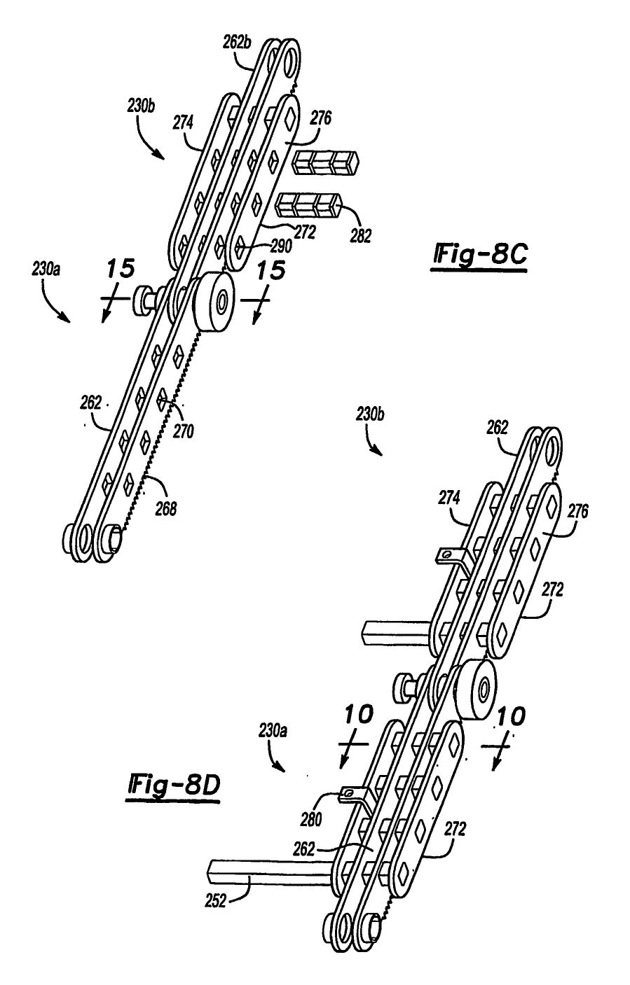

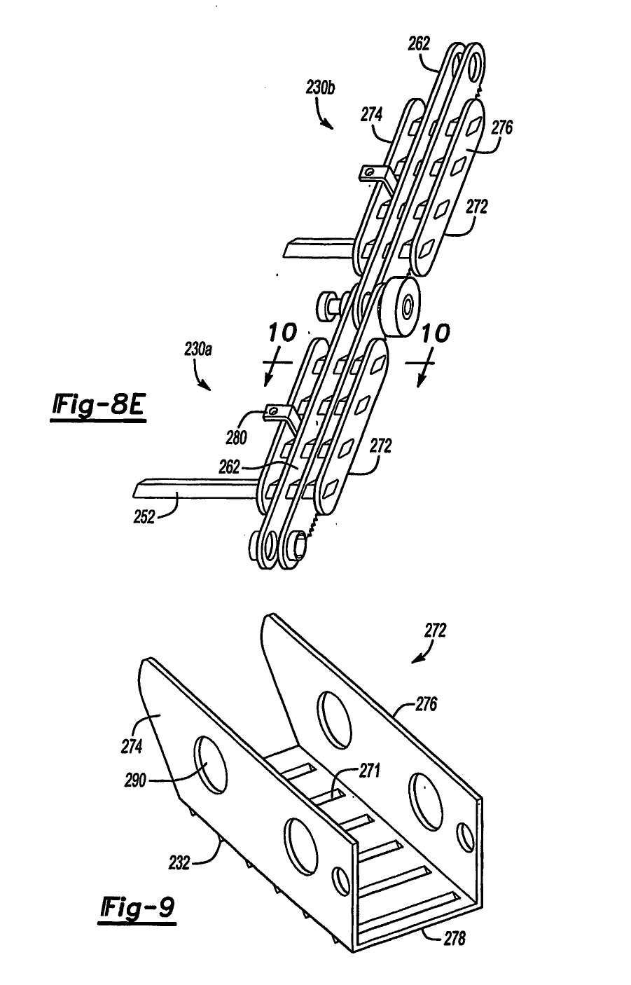

In another example, the stepchain links 230 are made of sheet metal portions, as shown in FIGS. 8A to 10. In one example, steel is the preferred material. The steel can be stamped or laser cut. FIGS. 8A to 8D show two links 230a and 230b at various stages of assembly.

Each stepchain link 230a and 230b in this example includes two inner portions 262. The inner portions 262 of the stepchain link 230b are spaced close together. The inner portions 262 of the stepchain link 230a are spaced farther apart and are outside of the inner portions 262 of the stepchain link 230b. Each inner portion has a first hole 264 near one end a second hole 266 at an opposite end. The inner portions 262 include a plurality of inner teeth 268 and a plurality of attachment holes 270. Although FIG. 8A illustrates four attachment holes 270 on each inner portion 262, it is to be understood that any number of attachment holes 270 can be employed.

The inner portions 262 are assembled in an alternating manner such that both the first holes 264 and the second holes 266 of a first stepchain link 230a are located outwardly of the first holes 264 and second holes 266 of the adjacent stepchain links 230b. That is, the second holes 266 of the inner portions 262 of a first stepchain link 230a are positioned outwardly of the first holes 264 of the inner portions 262 of a second stepchain links 230b. The second holes 266 of the inner portions 262 of the second stepchain link 230b are positioned inwardly of the first holes 264 of a third stepchain link (not shown). The second holes 266 of the inner portions 262 of the third stepchain link (not shown) are positioned outwardly of the first holes 264 of a fourth stepchain link (not shown), and so on.

As shown in FIG. 8B, an attachment member 284 is inserted in the aligned holes 264 of one link and 266 of an adjacent link to secure the inner portions of the links together. The holes 266 are larger than the holes 264, and needle bearings 290 (as shown in FIG. 15) are press fit in the holes 266, eliminating the need for lubrication. The needle bearings 290 rotate around the attachment member 284, reducing wear at the interface 231. The lubrication is sealed in the bearings 290 during assembly, eliminating the need to lubricate the bearing 290 during use.

Returning to FIG. 8B, the attachment member 284 is press fit in the holes 264 of the stepchain links 230b and in the needle bearings in the holes 266 of the stepchain links 230b. The needle bearings rotate around the attachment member 284. A cap 286 and a stepchain roller 288 are attached to the opposing ends of the attachment mechanism 284 after the attachment member 284 is inserted.

As shown in FIGS. 8C through 10, an outer portion 272 is attached to the inner portions of each link. In this example, each outer portion 272 is made up of two pieces, although more or fewer pieces could be used. The outer portion 272 includes a first side 274 and a second side 276 that are on opposite sides of the corresponding inner portion. A bottom surface 278 includes a plurality of teeth 232 having a profile that cooperates with the outer surface 34 of the drive member 36.

When assembled, as shown in FIGS. 8D and 10, the plurality of inner teeth 268 of the inner portions are nestingly received into grooves 271 on an inner side of the bottom surface 287. The outer portions 272 provide an engagement surface for the drive member 36 independently without bearing the tensile loads on the link. The inner portions bear the tensile load.

The inventive arrangement allows for a wide stepchain link 130, 230 and belt 36 interface (shown in FIG. 10) without having an undesirably high link weight. Preferably, the interface between the stepchain links 130, 230 and the belt 36 is 40 mm to 100 mm. Most preferably, the interface is 65 mm. There is also a substantially constant teeth 132 width and pitch across the span between adjacent teeth 132. The inner portions are advantageously heavier gauge steel in one example compared to the outer portions. The inner portions are strong enough to bear the tensile loads while the outer portions 272 provide more surface area for better engagement with the drive member 32. But the outer portions 272 need not carry the tensile loads.

Returning to FIGS. 8C and 8D, the sides 274 and 276 of each outer portion 272 include a plurality of attachment holes 290 that align with the attachment holes 270 of the corresponding inner portions. An attachment member 282 is inserted into the aligned holes 270 and 290 to secure the outer portion 272 to the inner portions. When assembled, the outer portion 272 of one stepchain link 230 does not contact the outer portion 272 of adjacent stepchain link 230. As shown in FIG. 8E, the attachment members 282 are inserted in the aligned attachment holes 270 and 290 and rotated up to 45° to create an interference fit.

FIG. 11 illustrates one of the attachment holes 290. In the illustrated example, each attachment hole 270 and 290 is generally square shaped and at least a portion of the attachment members 282 have a corresponding cross-section. In the illustrated example, the attachment members 282 are inserted in the aligned attachment holes 270 and 290 and rotated up to 45° to create an interference fit. It is to be understood that other shapes of the attachment holes 270 and 290 and attachment members 282 are possible.

Returning to FIG. 8D, an attachment member 282 having an axle 252 is inserted into the aligned holes 270 and 290 closest to the stepchain rollers 288. In one example, the aligned holes 270 and 290 also have a generally square cross-section and the attachment member 282 having the axle 252 has a corresponding cross section. The axle 252 is inserted into the aligned attachment holes 270 and 290 and rotated up to 45° to create an interference fit, securing the axle 252 to the stepchain links 230.

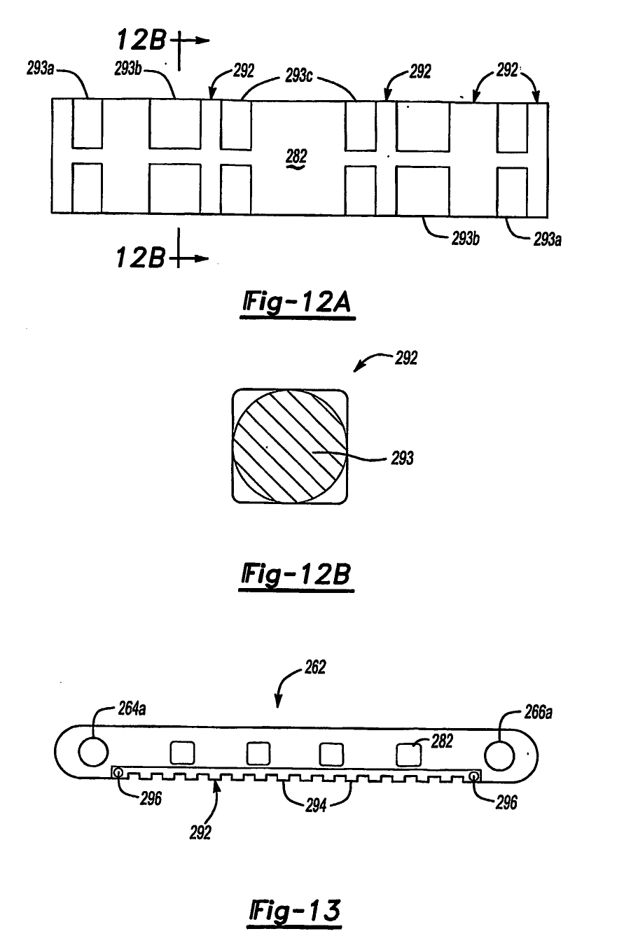

FIG. 12A illustrates a top view of an attachment member 282. FIG. 10 shows the attachment member 282 inserted into the aligned holes 270 and 290 of a stepchain link 230. Each attachment member 282 includes a plurality of flanges 292 that are spaced to receive the link portions between them. In one example, the each flanges 292 extend continually around the outer surface of the attachment member 282. The flanges 292 are positioned on opposite sides of grooves 293 between the flanges 292.

FIG. 12B illustrates an end view of the attachment member 282 of FIG. 12A. As shown, the corners of the grooves 293 are more rounded than the corners of the flanges 292. The attachment members 282 preferably are inserted such that the grooves 293a align with the holes 290 of the outer portion 272, the grooves 293b align with the holes 270 of the outwardly inner portions 262 of the stepchain links 230a, and the grooves 293c align with the holes 270 of the inwardly inner portions 262 of the stepchain links 230b.

When all the parts are properly aligned, the attachment member 282 can be rotated about its axis. The holes 270 and 290 and the outside geometry of the grooves 293 preferably cooperate to provide an interference fit when the attachment member 282 is rotated. The flanges 292 are configured to fit through the holes 270 and 290 during insertion and then to abut corresponding surfaces of the link portions once rotated. The flanges 292 engage the inner portions 262 and the sides 274 and 276 of the outer portion 272 and maintain the desired lateral spacing between the link portions.

As seen in FIG. 8D, a bridge support 280 attached to the inner portion provides a support for the bridge 49 during operation of the conveyor system 20 similar to the bridge support 180 of FIG. 4. The bridge support 280 is preferably attached to an inner portion by welding, pins, or the like.

Another example link configuration is shown in FIG. 13. An injection molded plate 292 having teeth 294 is snapped on the inner portions 262 and secured by an attachment member 296. The attachment member 296 can be a screw, pin, or another known fastener. The plate 292 provides a non-metallic drive member engagement surface on the links. By employing the plate 292 of injection molded teeth 294, corrosion is reduced.

Although multiple inner portions are used with each link in the illustrated example, one inner portion may be used. Similarly, more than two inner portions may be provided for each link.

The stepchain links 130 and 230 of the present invention carry the loads of the steps 24 and transfer the load from the drive member 36 to the plurality of stepchain links 130 and 230 through the plurality of teeth 132 and 232. Therefore, the stepchain links 130 and 230 carry the load of the passenger conveyor system 20.

The outer portions are may take a variety of forms, depending on the selected method of securing the inner an outer portions together. Those skilled in the art who have the benefit of this description will be able to select the best component design to met their particular needs.

There are several benefits to the stepchain links of the present invention. There is one stepchain link-to-stepchain link interface per step, reducing the number of stepchain links in the passenger conveyor system. Needle bearings are also employed between the stepchain links to reduce the need for lubrication. The chain stress value of the stepchain is also reduced as the drive mechanism is located in the inclined area of the passenger conveyor system. The teeth are also made of a single integrated piece of material.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A passenger conveyor system, comprising:
a plurality of steps moveable in a loop;
a drive member; and
a stepchain comprising a plurality of stepchain links that are associated with said steps, said stepchain links engaging said drive member such that movement of said drive member results in movement of said steps, said system further including at least one of:
a number of said stepchain links on one side of said steps being equal to a number of said steps; or
at least one needle bearing at an interface between adjacent links.

2. The assembly as recited in claim 1, comprising two of said stepchain, each having one of said interfaces associated with each of said steps such that adjacent stepchain links are connected to each other at said interface and wherein each stepchain link extends across a portion of adjacent steps.

3. The assembly as recited in claim 1 wherein each of said stepchain links includes a plurality of teeth that engage a corresponding set of teeth on said drive member and wherein said plurality of teeth are made of an integrated piece of material.

4. The assembly as recited in claim 1 wherein each of said plurality of stepchain links is attached to an adjacent stepchain link by an attachment member, and said at least one needle bearing is positioned between corresponding attachment members and corresponding stepchain links.

5. The assembly as recited in claim 1 wherein each of said plurality of steps includes a tread surface having a rear edge and a rise surface extending near a front edge of said tread surface, and said rear edge of each said tread surface moves along an arc of a circle as said plurality of steps move between an inclined portion and an adjacent landing portion of said passenger conveyor system.

6. The assembly as recited in claim 5 including a constant spacing between said rear edge of said tread surface of one of said plurality of steps and said rise surface of an adjacent one of said plurality of steps.

7. The assembly as recited in claim 1 including a constant spacing between said steps throughout movement of said steps along said loop.

8. The assembly as recited in claim 1 including a drive mechanism located in an inclined portion of said passenger conveyor system that drives said drive member and said plurality of stepchain links.

9. The assembly as recited in claim 1 wherein said plurality of teeth of said plurality of stepchain links have a substantially constant pitch which is substantially constant across a span between adjacent teeth.

10. The assembly as recited in claim 1 wherein each said stepchain link comprises a single piece of die cast metal.

11. The assembly as recited in claim 10 wherein said die cast metal is selected from the group consisting of aluminum and magnesium.

12. The assembly as recited in claim 10 wherein each of said stepchain links includes a first end having a hole and a second end having two spaced apart portions, each including a hole, said first end of one of said stepchain links is received at least partially between said second end portions of another of said plurality of stepchain links, and including an attachment member received through said holes to secure said first end of said one stepchain links to said second end of said another stepchain link, and further including needle bearings positioned between said holes of said two spaced apart portion of said second end and said attachment member.

13. A passenger conveyor system comprising:
a plurality of steps moveable in a loop;
a drive member; and
a plurality of stepchain links that are associated with said steps, said stepchain links engaging said drive member such that movement of said drive member results in movement of said steps, said steps and said stepchain links each moving along a constant radius arc as said steps transition between an inclined portion and a landing portion of said loop.

14. The system as recited in claim 13, including at least one needle bearing at an interface between adjacent links.

15. The system as recited in claim 13, wherein there is a number of stepchain links associated with each side of said steps and wherein a number of stepchain links on each side of the steps equals a number of steps.
